(19) United States
(12) Patent Application Publication
(10) Pub. No.: US 2010/0056050 A1
(43) Pub. Date: Mar. 4, 2010

(54) METHOD AND SYSTEM FOR AUDIO FEEDBACK PROCESSING IN AN AUDIO CODEC

(76) Inventors: Hongwei Kong, Denville, NJ (US); Taiyi Cheng, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 12/248,513

(22) Filed: Oct. 9, 2008

Related U.S. Application Data
(60) Provisional application No. 61/091,873, filed on Aug. 26, 2008.

(51) Int. Cl. H04B 7/00

(52) U.S. Cl. 455/41.2

(57) ABSTRACT

Aspects of a method and system for audio feedback processing in an audio CODEC are provided. In this regard, in a hardware audio CODEC for a wireless device, voice content from a first audio source may be mixed with audio content from one or more second audio sources to generate a composite audio signal. The composite audio may be transmitted to one or more far-end communication partners via a wireless communication channel. The wireless communication channel may be a channel of a cellular network. The composite audio signal may also be mixed with audio content received from a far-end communication partner and output to a local user via one or more audio output devices. The audio content from the second audio sources may comprise music played from a digital storage medium within the wireless device and/or music extracted from a signal received by the wireless device.

### CROSS-REFERENCE TO RELATED APPLICATIONS/INCORPORATION BY REFERENCE

This application makes reference to, claims priority to and claims benefit from U.S. Provisional Patent Application Ser. No. 61/091,873 filed on Aug. 26, 2008.

This application also makes reference to U.S. Provisional Patent Application Ser. No. 61/091,840 filed on Aug. 26, 2008.

Each of the above stated applications is hereby incorporated herein by reference in its entirety.

### FIELD OF THE INVENTION

Certain embodiments of the invention relate to processing of audio signals. More specifically, certain embodiments of the invention relate to a method and system for audio feedback processing in an audio CODEC.

### BACKGROUND OF THE INVENTION

In audio applications, systems that provide audio interface and processing capabilities may be required to support duplex operations, which may comprise the ability to collect audio information through a sensor, microphone, or other type of input device while at the same time being able to drive a speaker, earpiece of other type of output device with processed audio signal. In order to carry out these operations, these systems may comprise audio processing devices that provide appropriate gain, filtering, analog-to-digital conversion, and/or other processing of audio signals in an uplink direction and/or a downlink direction. In the downlink direction, an audio processing device may condition and/or process baseband audio signals from a receiver for presentation via audio output devices such as a loudspeaker and headphones. In an uplink direction, an audio processing device may process and/or condition audio signals received from an input device such as a microphone and convey the processed signals to a transmitter.

Limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for audio feedback processing in an audio CODEC, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary wireless system, which may be utilized in accordance with an embodiment of the invention.

FIG. 2A is a block diagram illustrating an exemplary audio processing device, in accordance with an embodiment of the invention.

FIG. 2B is a block diagram illustrating details of exemplary digital processing and analog processing portions of an audio processing device, in accordance with an embodiment of the invention.

FIG. 3 is a diagram illustrating sharing of audio with a far-end communication partner via a feedback processing path, in accordance with an embodiment of the invention.

FIG. 4 is a flow chart illustrating exemplary steps for sharing audio with a far-end communication partner via a feedback processing path, in accordance with an embodiment of the invention.

FIG. 5A is a block diagram illustrating an exemplary feedback audio processing block, in accordance with an embodiment of the invention.

FIG. 5B is a block diagram illustrating an exemplary linear interpolator, in accordance with an embodiment of the invention.

FIG. 6 is a flow chart illustrating exemplary steps for down-sampling audio signals to generate a feedback signal for transmission to a far-end communication partner, in accordance with an embodiment of the invention.

### DETAILED DESCRIPTION OF THE INVENTION

Certain aspects of the invention may be found in a method and system for audio feedback processing in an audio CODEC. In various exemplary embodiments of the invention, in a hardware audio CODEC for a wireless device, voice content from a first audio source may be mixed with audio content from one or more second audio sources to generate a composite audio signal. The generated composite audio may be transmitted to one or more far-end communication partners via a wireless communication channel. The wireless communication channel may be a channel of a cellular network. Exemplary audio sources may comprise a digital microphone, an analog microphone, a broadcast radio receiver, a Bluetooth receiver, a USB receiver, and a digital storage medium. The composite audio signal may also be mixed with audio content received from a far-end communication partner and output to a local user via one or more audio output devices. The audio content may comprise voice, music, and/or ringtone. Audio content from the second audio sources may comprise music played from a digital storage medium within the wireless device and/or music extracted from a signal received by the wireless device. The composite audio signal may be down-sampled to meet bandwidth limitations of the wireless network. Mixing, down-sampling, and/or transmitting performed in the wireless device may be enabled and disabled via one or more control signals. Prior to or during the mixing, the audio signal levels from each of the audio sources may be controlled independently.

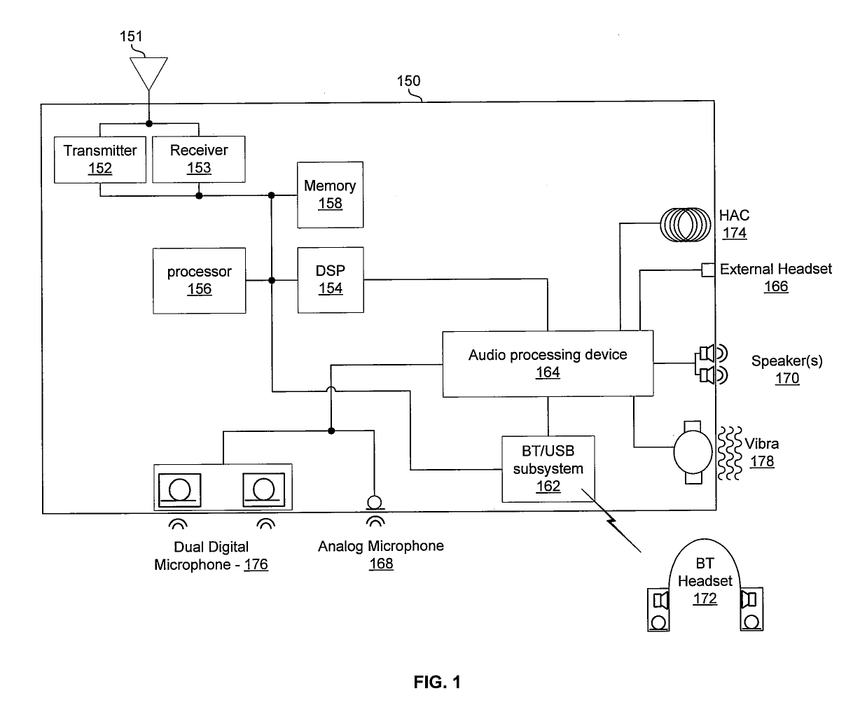

FIG. 1 is a block diagram of an exemplary wireless system, which may be utilized in accordance with an embodiment of the invention. Referring to FIG. 1, the wireless system 150 may comprise an antenna 151, a transmitter 152, a receiver 153, a digital signal processor 154, a processor 156, a memory 158, a Bluetooth (BT) and/or universal serial bus (USB) subsystem 162, an audio processing device 164, an external headset port 166, an analog microphone 168, speaker(s) 170, a Bluetooth headset 172, a hearing aid compatibility (HAC) coil 174, a dual digital microphone 176, and a vibration transducer 178. The antenna 151 may be used for reception and/or transmission of RF signals. Different wireless systems may use different antennas for transmission and reception.

The transmitter 152 may comprise suitable logic, circuitry, and/or code that may be operable to modulate and up-convert baseband signals to RF signals for transmission by one or more antennas, which may be represented generically by the antenna 151. The transmitter 152 may be operable to execute other functions, for example, filtering the baseband and/or RF signals, and/or amplifying the baseband and/or RF signals. Although a single transmitter 152 is shown, the invention is not so limited. Accordingly, there may be a plurality of transmitters and/or receivers. In this regard, the plurality of transmitters may enable the wireless system 150 to handle a plurality of wireless protocols and/or standards including cellular, wireless local area networking (WLAN), and personal area networking (PAN). In addition, the transmitter 152 may be combined with the receiver 153 and implemented as a combined transmitter and receiver (transceiver).

The receiver 153 may comprise suitable logic, circuitry, and/or code that may be operable to down-convert and demodulate received RF signals to baseband signals. The RF signals may be received by one or more antennas, which may be represented generically by the antenna 151. The receiver 153 may be operable to execute other functions, for example, filtering the baseband and/or RF signals, and/or amplifying the baseband and/or RF signals. Although a single receiver 153 is shown, the invention is not so limited. Accordingly, there may be a plurality of receivers. In this regard, the plurality of receivers may enable the wireless system 150 to handle a plurality of wireless protocols and/or standards including cellular, WLAN, PAN, and broadcast radio such as FM broadcast radio, “HD radio”, satellite radio, and digital audio broadcast (DAB) radio. In various embodiments of the invention, the receiver 153 may be implemented as a combined transmitter and a separate receiver. Exemplary cellular standards may comprise GSM and any variants thereof, CDMA and any variants thereof, and LTE and any variants thereof.

The DSP 154 may comprise suitable logic, circuitry, and/or code that may be operable to process audio signals. In various embodiments of the invention, the DSP 154 may encode, decode, modulate, demodulate, encrypt, and/or decrypt audio signals. In this regard, the DSP 154 may be operable to perform computationally intensive processing of audio signals.

The processor 156 may comprise suitable logic, circuitry, and/or code that may be operable to configure and/or control one or more portions of the system 150, control data transfers between portions of the system 150, and/or otherwise process data. Control and/or data information may be transferred between the processor 156 and one or more of the transmitter 152, the receiver 153, the DSP 154, the memory 158, the audio processing device 164, and the BT and/or USB subsystem 162. The processor 156 may be utilized to update and/or modify programmable parameters and/or values in one or more of the transmitter 152, the receiver 153, the DSP 154, the memory 158, the audio processing device 164, and the BT and/or USB subsystem 162. In this regard, a portion of the programmable parameters may be stored in the system memory 158. The processor 156 may be any suitable processor or controller. For example, the processor may be a reduced instruction set computing (RISC) microprocessor such as an advanced RISC machine (ARM), advanced virtual RISC (AVR), microprocessor without interlocked pipeline stages (MIPS), or programmable intelligent controller (PIC).

The system memory 158 may comprise suitable logic, circuitry, and/or code that may be operable to store a plurality of control and/or data information, including parameters needed to configure one or more of the transmitter 152, the receiver 153, the DSP 154, and/or the audio processing device 164. The system memory 158 may store at least a portion of the programmable parameters that may be manipulated by the processor 156.

In an exemplary embodiment of the invention, the DSP 154 and processor 156 may exchange audio data and control information via the memory 158. For example, the processor 156 may write encoded audio data, such as MP3 or AAC audio, to the memory 158 and the memory may pass the encoded audio data to the DSP 154. Accordingly, the DSP 154 may decode the data and write pulse-code modulated (PCM) audio back into the shared memory for the processor 156 to access and/or to be delivered to the audio processing device 164.

The BT and/or USB subsystem 162 may comprise suitable circuitry, logic, and/or code that may be operable to transmit and receive Bluetooth and/or Universal Serial Bus (USB) signals. The BT and/or USB subsystem 162 may be operable to up-convert, down-convert, modulate, demodulate, and/or otherwise process BT and/or USB signals. In this regard, the BT and/or USB subsystem 162 may handle reception and/or transmission of BT and/or USB signals via a wireless communication medium and/or handle reception and/or transmission of USB signals via a wireline communication medium. Information and/or data received via a BT and/or USB connection may be communicated between the BT and/or USB subsystem 162 and one or more of the transmitter 152, the receiver 153, the DSP 154, the processor 156, the memory 158, and the audio processing device 164. For example, the BT and/or USB subsystem 162 may extract audio from a received BT and/or USB signal and may convey the audio to other portions of the wireless system 150 via an inter-IC sound (I²S) bus. Information and/or data may be communicated from one or more of the transmitter 152, the receiver 153, the DSP 154, the processor 156, the memory 158, and the audio processing device 164 to the BT and/or USB subsystem 162 for transmission over a BT and/or USB connection. For example, audio signals may be received from other portions of the wireless system 150 via an I²S bus and the audio signal may be transmitted via a BT and/or USB connection. Additionally, control and/or feedback information may be communicated between the BT and/or USB subsystem 162 and one or more of the transmitter 152, the receiver 153, the DSP 154, the processor 156, the memory 158, and the audio processing device 164.

The audio processing device 164 may comprise suitable circuitry, logic, and/or code that may be operable to process audio signals received from and/or communicated to input and/or output devices. The input devices may be within or communicatively coupled to the wireless device 150, and may comprise, for example, the analog microphone 168, the stereo speakers 170, the Bluetooth headset 172, the hearing aid compatible (HAC) coil 174, the dual digital microphone 176, and the vibration transducer 178. The audio processing device 164 may up-sample and/or down-sample audio signals to one or more desired sample rates for communication to an audio output device, the DSP 154, and/or the BT and/or USB subsystem 162. In this regard, the audio processing device 164 may also be enabled to handle a plurality of data sampling rate inputs. For example, the audio processing device 164 may accept digital audio signals at sampling rates such as 8 kHz, 11.025 kHz, 12 kHz, 16 kHz, 22.05 kHz, 24 kHz, 32 kHz, 44.1 kHz, and/or 48 kHz. The audio processing device 164 may be enabled to handle a plurality of digital audio inputs of various resolutions, such as 16 or 18-bit resolution, for example. The audio processing device 164 may support mixing of a plurality of audio sources. For example, the audio processing device 164 may support audio sources such as general audio, polyphonic ringer, I²S FM audio, vibration driving signals, and voice. In an exemplary embodiment of the invention, the general audio and polyphonic ringer sources may support the plurality of sampling rates that the audio processing device 164 may be enabled to accept, while the voice source may support a portion of the plurality of sampling rates, such as 8 kHz and 16 kHz.

The audio processing device 164 may utilize a programmable infinite impulse response (IIR) filter and/or a programmable finite impulse response (FIR) filter for at least a portion of the audio sources to compensate for passband amplitude and phase fluctuation for different input and/or output devices. In this regard, filter coefficients may be configured or programmed dynamically based on operations. Moreover, filter coefficients may all be switched in one-shot or may be switched sequentially, for example. The audio processing device 164 may also utilize a modulator, such as a Delta-Sigma (ΔΣ) modulator, for example, to code digital output signals for analog processing. The audio processing device 164 may be referred to, for example, as an audio coding and/or decoding device or CODEC. In various embodiments of the invention, the audio processing device 164 may be implemented in dedicated hardware.

The external headset port 166 may comprise a physical connection for an external headset to be communicatively coupled to the wireless system 150. The headset may, for example, be an analog headset comprising a microphone and a pair of stereo transducers. Alternatively, the headset may be a digital headset which may utilize a protocol such as USB for communicating audio information.

The analog microphone 168 may comprise suitable circuitry, logic, and/or code that may detect sound waves and convert them to electrical signals via a piezoelectric effect, for example. The electrical signals generated by the analog microphone 168 may comprise analog signals that may require analog to digital conversion before processing.

The one or more speakers 170 may be operable to generate acoustic waves from electrical signals received from the audio processing device 164. In an exemplary embodiment of the invention, there may be a pair of speakers which may be operable to output acoustic waves corresponding to, for example, left and right stereo channels.

The Bluetooth headset 172 may comprise a wireless headset that may be communicatively coupled to the wireless system 150 via the BT and/or USB subsystem 162. In this manner, the wireless system 150 may be operated in a hands-free mode, for example.

The HAC coil 174 may comprise suitable circuitry, logic, and/or code that may be operable to enable communication between the wireless device 150 and a hearing aid, for example. In this regard, audio signals may be magnetically coupled from the HAC coil 174 to a coil in a user's hearing aid.

The dual digital microphone 176 may comprise suitable circuitry, logic, and/or code that may be operable to detect sound waves and convert them to electrical signals. The electrical signals generated by the dual digital microphone 176 may comprise digital signals, and thus may not require analog to digital conversion prior to digital processing in the audio processing device 164.

The vibration transducer 178 may comprise suitable circuitry, logic, and/or code that may be operable to notify a user of events on the wireless device 150 such as calendar reminders, a low battery notification, a received signal strength notification, an incoming call, and an incoming message without the use of sound. Aspects of the invention may enable the vibration transducer 178 to generate vibrations that may be in synch with, for example, audio signals such as speech, music, ringtones, and/or continuous wave (CW) tones.

In operation, audio signals from the receiver 153, the processor 156, and/or the memory 158 may be conveyed to the DSP 154. The DSP 154 may process the signals to generate output baseband audio signals to the audio processing device 164. Additionally, baseband audio signals may be conveyed from the BT and/or USB subsystem 162, the analog microphone 168, and/or the digital microphone 176, to the audio processing device 164.

The audio processing device 164 may process and/or condition one or more of the baseband audio signals to make them suitable for conveyance to the one or more speakers 170, the headset 166, the HAC 174, the vibration transducer 178, the transmitter 152, and/or the BT and/or USB subsystem 162. In this regard, signals processed by the audio processing device 164 may be conveyed, via a feedback path, to the transmitter 152 for transmission to a far-end communication partner. For example, a near-end user of the wireless device 150 may be listening to music on the wireless system 150 and the music may be conveyed to the transmitter 152 for communication to a far-end communication partner. In this manner, a near-end user may be enabled to share music with a far-end user. In various embodiments of the invention, audio processed in a feedback path may be down-sampled or otherwise processed so as to be suitable for communication over existing wireless standards. Additionally, detected signal amplitudes may be utilized to generate an audio visualization. For example, one or more LEDs or an image displayed by the wireless system 150 may be controlled based on the detected signal amplitudes.

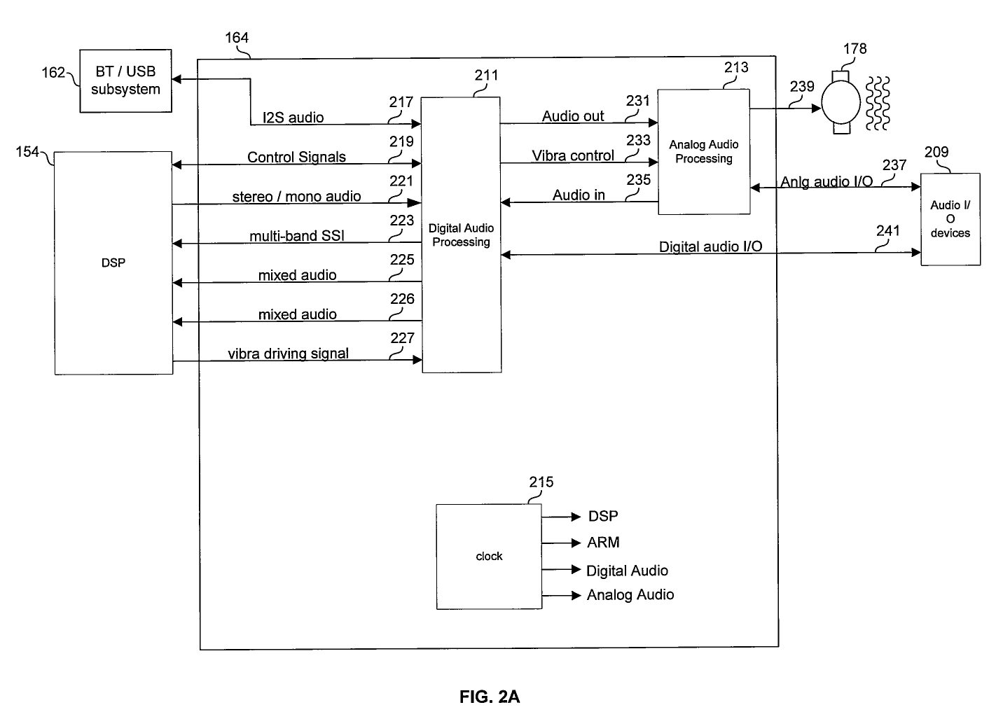

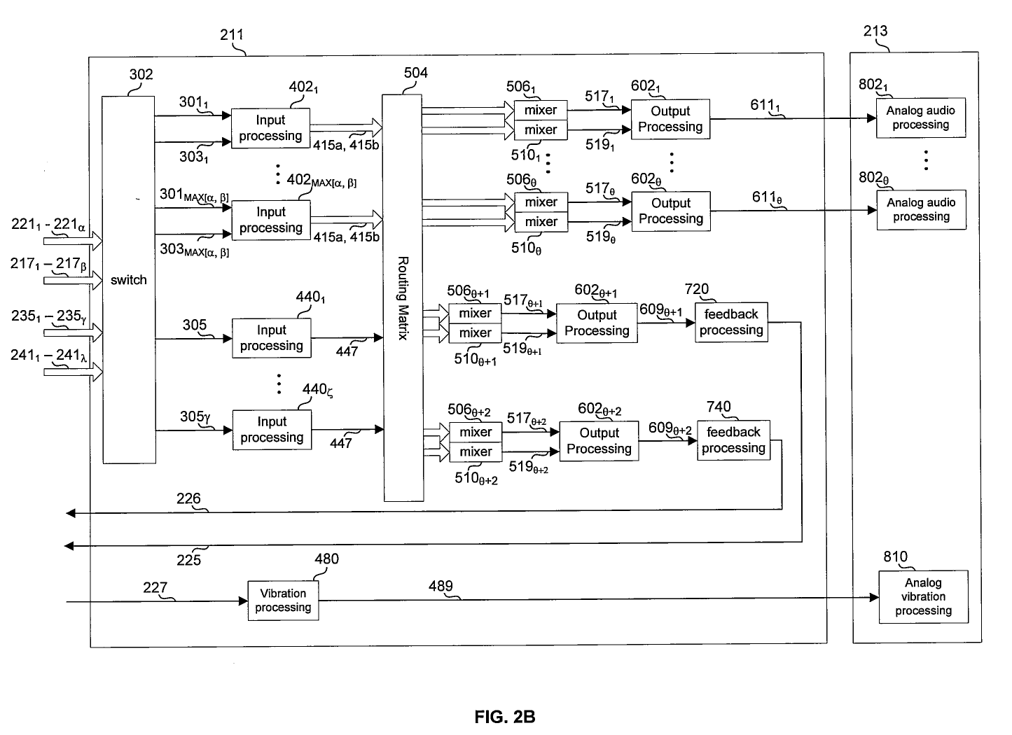

FIG. 2A is a block diagram illustrating an exemplary audio processing device, in accordance with an embodiment of the invention. Referring to FIG. 2A, there is shown the DSP 154, the BT and/or USB subsystem 162, the audio processing device 164, and audio input and/or output devices 209. The audio input and/or output devices 209 may comprise one or more devices such as the external headset port 166, the analog microphone 168, the speakers 170, the Bluetooth headset 172, the hearing aid compatibility (HAC) coil 174, the dual digital microphone 176, and the vibration transducer 178 described with respect to FIG. 1. The DSP 154 and the BT and/or USB subsystem 162 may be as described with respect to FIG. 1. The audio processing device 164 may be as described with respect to FIG. 1 and may comprise a digital portion 211, an analog portion 213, and a clock 215.

The digital portion 211 may comprise suitable logic, circuitry, and/or code that may enable processing audio signals in the digital domain. In this regard, the digital portion 211 may be operable to filter, buffer, up-sample, down-sample, apply a digital gain or attenuation to, route, and/or otherwise condition digital audio signals. Additional details of the digital portion 211 are described below with respect to FIGS. 2B, 3, 4, 5A, and 5B.

The analog portion 213 may comprise suitable logic, circuitry, and/or code that may enable conversion of digital audio signals to an analog representation and amplifying and/or buffering the analog signals for driving audio output devices. Additional details of the analog portion 213 are described below with respect to FIG. 2B.

The clock 215 may comprise suitable logic, circuitry, and/or code that may be operable to generate one or more periodic signals. The clock 215 may, for example, comprise one or more crystal oscillators, phase locked loops (PLLs), and/or direct digital frequency synthesizers (DDFS). The clock 215 may output a plurality of signals each with a distinct frequency and/or phase. The signals output by the clock 215 may be conveyed to one or more of the digital portion 211, the analog portion 213, the DSP 154, the memory 158, and/or the processor 156.

In various exemplary embodiments of the invention, one or more audio signals 217 may be communicated between the digital portion 211 and the BT and/or USB subsystem 162 via an inter-IC sound (I²S) bus. Each of the audio signals 217 may be a monaural channel, a left stereo channel, or a right stereo channel. In an exemplary embodiment of the invention, the BT and/or USB subsystem 162 may be enabled to receive and/or process audio broadcasts, and thus, two signals 217 comprising left and right channel audio may be conveyed to the digital portion 211 via an I²S bus. In this regard, exemplary audio broadcasts may comprise FM stereo, “HD radio”, DAB, DAB+, and satellite radio broadcasts.

In various exemplary embodiments of the invention, one or more output audio signals 231, vibration control 233, and input audio signals 235 may be communicated between the digital portion 211 and the analog portion 213.

The output audio signals 231 may each comprise one or more digital audio signals which have been suitably processed and/or conditioned by the digital portion 211 for output via one or more of the audio output devices 209. Each of the audio signals 231 may be a monaural channel, a left stereo channel, or a right stereo channel. Each of the output audio signals 231 may be converted to an analog representation and amplified by the analog portion 213.

The input audio signals 235 and 241 from an audio input device 209 may each comprise one or more digital audio signals to be processed by the digital portion 211. The input audio signals 235 and/or 241 may comprise monaural and/or stereo audio data which the digital portion 211 may process for conveyance to the DSP 154 and subsequent transmission to a remote wireless device. The input audio signals 235 and/or 241 may comprise monaural and/or stereo audio data which the digital portion 211 may process in a “loopback” path for conveyance to one or more audio output devices 209.

The vibration control signal 233 may be pulse width modulated square wave that may, after being amplified by the analog processing portion 213, control vibration of the vibration transducer 178. In various exemplary embodiments of the invention, spectral shaping techniques may be applied in the pulse width modulation function to reduce noise in the audible band.

In various exemplary embodiments of the invention, one or more control signals 219, one or more audio signals 221, one or more SSI signals 223, one or more mixed audio signals 225 and/or 226, and one or more signals 227 for driving a vibration transducer may be communicated between the DSP 154 and the digital portion 211. Monaural and/or stereo audio data may be extracted from RF signals received by the receiver 153 and processed by the DSP block 154 before being conveyed to the digital portion 211 of the processing device 164. One or more signals communicated between the DSP 154 and the digital portion 211 may be buffered. For example, voice signals may not be buffered while music and/or ringtone signals may be written to a first-in-first-out (FIFO) buffer by the DSP 154 and then fetched from the FIFO by the digital portion 211.

The one or more control signals 219 may be utilized to configure various operations of the digital portion 211 based, for example, on a resolution and/or sampling rate of signals being output by the DSP 154. In various embodiments of the invention, one or more control registers for the digital portion 211 may reside in the DSP 154. In various embodiments of the invention, the control signals 219 may comprise one or more interrupt signals.

The audio signals 221 may each comprise, for example, voice data, music data, or ringtone data. Each audio signal 221 may be monaural signal, a left stereo channel, or a right stereo channel. The digital portion 211 may condition and/or process the audio signals 221 for conveyance to one or more audio output devices and/or uplink paths. In various embodiments of the invention, the resolution and/or sample rate of the audio signals 221 may vary. Exemplary resolutions may comprise 16-bit and 18-bit resolution. Exemplary sample rates may comprise 8 kHz, 11.05 kHz, 12 kHz, 16 kHz, 22.05 kHz, 24 kHz, 32 kHz, 44.1 kHz, and 48 kHz.

The signal strength indicator (SSI) signals 223 may comprise one or more feedback signals from the digital portion 211 to the DSP 154. The SSI signals 223 may provide an indication of signal strength of one or more frequency bands of one or more audio signals 221, 225, and/or 226. The SSI signals 223 may, for example, be utilized by the DSP 154, the processor 156, the memory 158, or a combination thereof to control a digital gain factor applied to each sub-band of one or more audio signals 221, 225, and/or 226. In various embodiments of the invention, the SSI signals 223 may be utilized for audio visualizations. For example, one or more LEDs and/or an image on a display may be controlled based on audio signal strength.

The signal 227 may comprise audio data utilized to control a vibration transducer 178. The signal 227 may comprise, for example, CW tone data, voice data, music data, or ringtone data. Characteristics such as intensity of vibration, a pattern in which vibration is started and stopped, a frequency at which vibration is started and stopped, and duration of a vibration or sequence of vibrations may be controlled based on the signal 227.

The one or more mixed audio signals 225 and the one or more mixed audio signals 226 may be generated via a feedback path of the digital portion 211 and conveyed to the DSP 154. The mixed audio signals 225 may each be a composite signal comprising information from one or more monaural signals and/or stereo audio signals. Similarly, the mixed audio signals 226 may each be a composite signal comprising information from one or more monaural signals and/or stereo audio signals. In this regard, one or more of the audio signals 221, one or more of the input audio signals 235, one or more of the input audio signals 241, and/or one or more of the audio signals 217 may be mixed together. Each of the audio signals 221, 235, 241, and 217 may be, for example, amplified, attenuated, band limited, up-converted, down-converted or otherwise processed and/or conditioned prior to mixing. The mixed audio signals 225 may be part of and/or coupled to an uplink path. For example, the signals 225 may be processed by the DSP 154 and transmitted, via the BT and/or USB subsystem 162, to a remote wireless system. Similarly, the mixed audio signal 226 may be part of and/or coupled to an uplink path. For example, the signals 226 may be processed by the DSP 154 and transmitted, via the transmitter 152, to a far-end communication partner or a remote wireless system. In this manner, audio processed by the audio CODEC 164 for output to a near-end user may also be fed-back to the transmitter 152 for transmission to a far-end communication partner.

In operation, one or more baseband audio signals 217, 221, 235, and/or 241 may be conveyed to the audio processing device 164 from one or more of the DSP 154, the BT and/or USB subsystem 162, and the input and/or output devices 209. The digital portion 211 of the audio processing device 164 may select which baseband audio signals 221 to process. Each of the selected audio signals may be processed based on factors such as whether the signal is one of a pair of stereo signals or is a monaural signal; whether the signal comprises voice, music, or ringtone data; a resolution of the signal; and a sample rate of the signal. Selected audio signals may be processed in an input processing path comprising one or more input audio processing blocks 402 and/or 440 (FIG. 2B). The input audio processing path may condition audio signals based on source and/or characteristics of the audio signal. Subsequently, audio signals may be mapped from one or more input processing paths to one or more output processing paths. The output processing path may comprise one or more mixers 506 and/or 510 (FIG. 2B), output audio processing blocks 602 (FIG. 2B), feedback audio processing block 720 (FIG. 2B), and/or feedback processing block 740 (FIG. 2B). The output processing path may condition signals based on one or more output devices 209 and/or uplink paths to which the audio signals may be conveyed

FIG. 2B is a block diagram illustrating details of exemplary digital processing and analog processing portions of an audio processing device, in accordance with an embodiment of the invention. Referring to FIG. 2B, there is shown a digital portion 211 and an analog portion 213.

The digital portion 211 may comprise a switching element 302, a plurality of input audio processing blocks 402, a plurality of input audio processing blocks 440, a digital vibration processing block 480, a routing matrix 504, a plurality of mixers 506 and 510, a plurality of output audio processing blocks 602, a feedback audio processing block 720, and a feedback audio processing block 740.

The switching element 302 may be operable to route one or more of the signals 221₁ . . . 221_{α} (collectively referred to herein as signals 221), 217₁ . . . 217_{β} (collectively referred to herein as signals 217), 235₁ . . . 235_{γ} (collectively referred to herein as signals 235), and/or 241₁ . . . 241_{λ} (collectively referred to herein as signals 241) from the DSP 154, BT and/or USB subsystem 162, and audio input devices 209 to the digital portion 211, where α, β, γ and λ are integers greater than or equal to 1. Which signals 221, 217, 235, and/or 241 are routed to one or more input audio processing blocks 402 and/or 440 may be determined based on one or more control signals received from, for example, the DSP 154, the processor 156, and/or the BT and/or USB subsystem 162. In this regard, the switching element 302 may be configured dynamically and/or real-time so as to provide processing whenever it may be required.

Each of the input audio processing blocks 402 may comprise suitable logic, circuitry, and/or code that may be operable to condition monaural or stereo input audio signals. Processing of an audio signal by each of the input audio processing blocks 402 may be based on a type of audio content in the signal, a source of the audio signal, and/or a sample rate of the audio signal. Exemplary sources of audio content may comprise FM broadcast stations, “HD radio” stations, satellite radio stations, and DAB stations. Additionally and/or alternatively, audio content may be provided over the cellular network by a cellular service provider. Each of the input audio processing blocks 402 may be operable to buffer an audio signal 301 and/or 303. One or more of the input audio processing blocks 402 may be operable to control whether audio data is processed as a left stereo channel, a right stereo channel, or a monaural signal. Each of the input audio processing blocks 402 may be operable to measure strength of one or more audio signals 301 and/or 303 and generate one or more feedback signals corresponding to the measured strength. Each of the input audio processing blocks 402 may be operable to filter the one or more audio signals 301 and/or 303 and/or up-sample and/or down-sample the audio signals 301 and/or 303. Each of the input audio processing blocks 402 may be operable to adjust signal levels of the signals 415a and 415b. In various embodiments of the invention, one or more of the input audio processing blocks 402 may be configured via one or more control signals received from, for example, the DSP 154, the processor 156, and/or the BT and/or USB subsystem 162. In this regard, the input audio processing blocks 402 may be configured dynamically and/or real-time so as to provide processing whenever it may be required.

Each of the input audio processing blocks 440 may comprise suitable logic, circuitry, and/or code that may be operable to condition monaural input audio signals. Processing of an audio signal 305 by each of the input audio processing blocks 440 may be based on a type of audio content in the signal 305, a source of the audio signal 305, and/or a sample rate of the audio signal 305. Each of the input audio processing blocks 440 may be operable to buffer an audio signal 305, filter the audio signal 305, and/or up-sample or down-sample the audio signal 305. Each of the input audio processing blocks 440 may be operable to adjust signal levels of the signal 447. In various embodiments of the invention, one or more of the input audio processing blocks 440 configured via one or more control signals received from, for example, the DSP 154, the processor 156, and/or the BT and/or USB subsystem 162. In this regard, the input audio processing blocks 440 may be configured dynamically and/or real-time so as to provide processing whenever it may be required.

The digital vibration processing block 480 may comprise suitable logic, circuitry, and/or code that may be operable to process and/or condition one or more of the baseband audio signals to generate one or more signals 489 for controlling the vibration transducer 178. In this regard, the digital vibration processing block 480 may be operable to control vibrations based on an audio signal. In an exemplary embodiment of the invention, various characteristics such as intensity of vibration, a pattern in which vibration is started and stopped, a frequency at which vibration is started and stopped, and/or duration of a vibration or sequence of vibrations may be controlled based on an audio signal input to the digital vibration processing block 480. The digital vibration processing block 480 may be configured via one or more control signals received from, for example, the DSP 154, the processor 156, and/or the BT and/or USB subsystem 162. In this regard, the digital vibration processing block 480 may be configured dynamically and/or real-time so as to provide processing whenever it may be required.

The routing matrix 504 may comprise suitable logic, circuitry, and/or code that may be operable to route each of the signals 415 and 447 to one or more of the mixers 506 and/or 510. The routing matrix 504 may be configured via one or more control signals from, for example, the processor 156, the DSP 154, and/or the memory 158. Moreover, configuration of the routing matrix 504 may occur dynamically and/or in real-time so as to provide processing whenever it may be required. In various embodiments of the invention, the routing matrix 504 may comprise one or more multiplexers or similar switching elements. Routing of each input signal 415 and/or 447 may depend, at least in part, on an output device 209 and/or uplink path for which each signal 415 and 447 may be destined. In this regard, the routing and re-routing of signals between inputs and outputs of the audio processing device 164 may occur in real-time.

Routing of each input signal 415 and/or 447 may be independent of the routing of other input signals 415 and 447, independent of the source of each signal 415 and/or 447, and independent of whether each signal 415 and/or 447 is a stereo channel or a monaural channel. Thus, upstream from the routing matrix 504 audio signals may be processed according to an input of the processing device 164 on which the audio signals where received and downstream from the routing matrix 504 audio signals may be processed based on an output of the processing device 164 for which the signals are destined. In this manner, the processing device 164 may provide flexibility in routing audio signals of various types from various sources to one or more audio output devices and/or uplink paths. Upstream from the routing matrix 504 may comprise the input audio processing blocks 402 and 440. Downstream from the routing matrix 504 may comprise the mixers 506 and 510, the output audio processing blocks 602, the feedback audio processing block 720, and the feedback audio processing block 740.

The mixers 506 and 510 may each comprise suitable logic, circuitry, and/or code that may be operable to combine audio signals into a composite audio signal. Each mixer 506 may combine up to η audio signals to generate a composite audio signal 517. Similarly each mixer 510 may combine up to η audio signals to generate a composite audio signal 519. In various embodiments of the invention, each signal 517₁ . . . 517_{θ+2}, may be a left stereo channel and each signal 519₁ . . . 519_{θ+2}, may be a right stereo channel. In an exemplary embodiment of the invention, the mixers 506 and 510 may output up to θ+2 stereo signals or up 2(θ+2) monaural signals to a number, θ, of analog audio processing blocks 802, an uplink processing block 720, and an uplink processing block 740 via the output audio processing blocks 602. The mixers 506 and 510 may be configured via one or more control signals from, for example, the processor 156, the DSP 154, and/or the memory 158. In this regard, the mixers 506 and/or 510 may be configured dynamically and/or real-time so as to provide processing whenever it may be required.

Each output audio processing blocks 602 may comprise suitable logic, circuitry, and/or code that may be operable to process audio signals for conveyance to one or more analog audio processing blocks 802, an uplink processing block 720, and an uplink processing block 740.

The feedback audio processing block 720 may comprise suitable logic, circuitry, and/or code that may be operable to process and/or condition one or more of the baseband audio signals to generate one or more signals 225. In various embodiments of the invention, one or more signals 225 may be conveyed to an uplink signal path via the DSP 154 and/or the BT and/or USB subsystem 162. In this regard, the audio signal(s) 225 may comprise voice, music, and/or ringtone data which may be communicated to a remote wireless device utilizing BT and/or USB protocols. In various embodiments of the invention, one or more signals 225 may be conveyed to an output device such as the BT headset 172 via the BT and/or USB subsystem 162. The feedback audio processing block 720 may be operable to up-sample and/or down-sample audio signals, adjust signal levels of the output signal 225, and/or buffer audio signals. The feedback audio processing block 720 may be configured via one or more control signals received from, for example, the DSP 154, the processor 156, and/or the BT and/or USB subsystem 162. In this regard, the uplink audio processing block 720 may be configured dynamically and/or real-time so as to provide processing whenever it may be required.

The feedback audio processing block 740 may comprise suitable logic, circuitry, and/or code that may be operable to process and/or condition one or more of the baseband audio signals to generate one or more signals 226 for conveyance to an uplink signal path via the DSP 154 and/or transmitter 152. In this regard, the audio signal 226 may comprise voice, music, and/or ringtone data which may be communicated to a remote wireless device utilizing, for example, cellular, WLAN, and/or PAN protocols. For example, music processed by the wireless device 150 may be output via the speakers 170 and may also be fed-back to the transmitter 152 for transmission to a far-end communication partner. In this manner, music or other audio on the near end may be shared with a device or user on the far-end. In various embodiments of the invention, the audio fed-back to the far-end may be down-sampled or otherwise processed so as to be compatible with wireless communication standards. The feedback audio processing block 740 may be operable to up-sample and/or down-sample audio signals. The feedback audio processing block 740 may be configured via one or more control signals received from, for example, the DSP 154, the processor 156, and/or the BT and/or USB subsystem 162. In this regard, the feedback audio processing block 740 may be configured dynamically and/or real-time so as to provide processing whenever it may be required.

Each of the analog audio processing blocks 802 may comprise suitable logic, circuitry, and/or code that may be operable to condition audio signals for driving an audio output device 209. Each analog audio processing block 802 may be operable to convert a digital audio signal to an analog representation. Each analog audio processing block 802 may be operable to buffer and/or amplify analog audio signals for driving an audio output device 209. The analog audio processing blocks 802 may be configured via one or more control signals, which may be received from, for example, the DSP 154, the processor 156, and/or the BT and/or USB subsystem 162. In this regard, the analog audio processing blocks 802 may be configured dynamically and/or real-time so as to provide processing whenever it may be required.

The analog vibration processing block 810 may comprise suitable logic, circuitry, and/or code that may be operable to buffer and/or amplify the signal 489 for driving the vibration transducer 178. In this regard, driving the vibration transducer 178 may require more current than the digital vibration processing block 480 may be able to output and thus the analog vibration processing block 810 may provide increased output current for driving the vibration transducer 178. The analog vibration processing block 810 may be configured via one or more control signals received from, for example, the DSP 154, the processor 156, and/or the BT and/or USB subsystem 162. In this regard, the analog vibration processing block 810 may be configured dynamically and/or real-time so as to provide processing whenever it may be required.

In operation, the switching element 302 may select one or more audio signals to be routed to one or more of the input audio processing blocks 402 and/or the input audio processing blocks 440. Each of the input audio processing blocks 402 and/or 440 may condition audio signals and convey them to the routing matrix 504. The routing matrix 504 may route the audio signals to one or more mixers 506 and/or 510. Each of the mixers 506 and/or 510 may be operable to mix together one or more audio signals into a composite audio signal 517 and/or 519. The signals 517 and/or 519 may each be conveyed to an output audio processing block 602. Each of the output audio processing blocks 602 may condition audio signals for conveyance to an analog audio processing block 802, a feedback audio processing block 720, or a feedback audio processing block 740. The signals 611₁, . . . , 611_{θ} may each be conveyed to an analog processing block 802 which may convert the signals 611₁, . . . , 611_{θ}to an analog representation and buffer and/or amplify the analog audio signal to drive an audio output device 209.

In accordance with an embodiment of the invention, a feedback path for communicating mixed audio to a remote device via BT and/or USB protocols may comprise the mixers 506_{θ+1} and 510_{θ+1}, the output audio processing block 602_{θ+1}, and the feedback audio processing block 720. Accordingly, the feedback path may be enabled by configuring the routing matrix 504 to convey one or more audio signals to the mixer(s) 506_{θ+1} and/or 510_{θ+1}. In instances that audio is routed to mixer(s) 506_{θ+1} and/or 510_{θ+1}, the feedback audio processing block 720 may condition the signal 609_{θ+2} for transmission to a BT and/or USB enabled device. A feedback path for communicating mixed audio to a far-end user may comprise the mixers 506_{θ+2} and 510_{θ+2}, the output audio processing block 602_{θ+2}, and the feedback audio processing block 740. Accordingly, the feedback path may be enabled by configuring the routing matrix 504 to convey one or more audio signals to the mixer(s) 506_{θ+2} and/or 510_{θ+2}. In instances that audio is routed to mixer(s) 506_{θ+2} and/or 510_{θ+2}, the feedback audio processing block 740 may condition the signal 609_{θ+2} for transmission to a far-end communication partner.

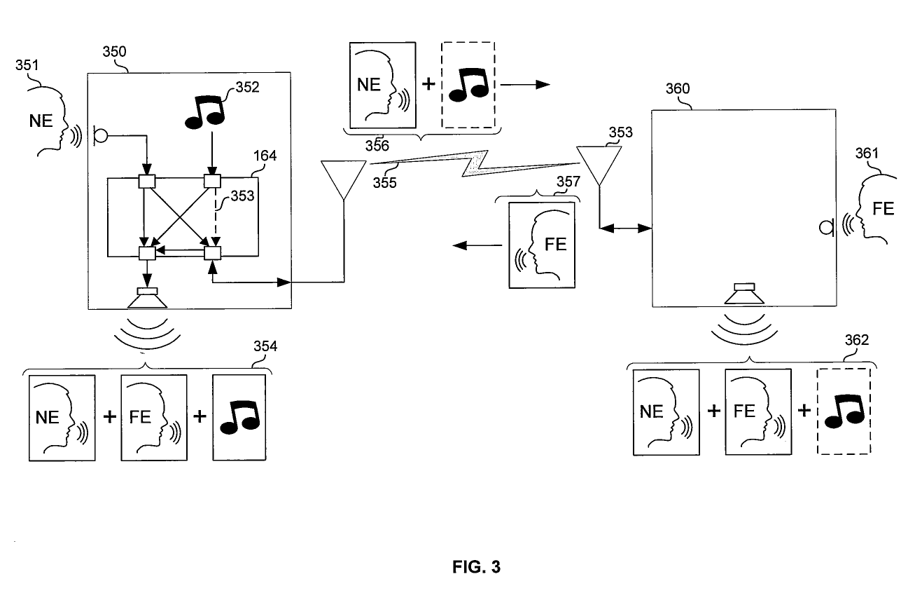

FIG. 3 is a diagram illustrating sharing of audio with a far-end communication partner via a feedback processing path, in accordance with an embodiment of the invention. Referring to FIG. 3 there is shown a near-end wireless device 350, a communication channel 355, and a far-end wireless device 360.

The near-end wireless device 350 may comprise suitable logic, circuitry, and/or code that may be operable to generate, receive, and/or otherwise process audio information for presentation to a near-end user and for communication to a far-end communication partner via the wireless channel 355. In this regard, the near-end wireless device 350 may output audio 354 locally and may communicate audio 356 over the wireless channel 355. The near-end wireless device 350 may be similar to or the same as the wireless system 150 described with respect to FIG. 1 and may comprise a audio CODEC 164 as described with respect to FIGS. 1, 2A, 2B, 4, 5A, 5B, and 6.

The far-end wireless device 360 may comprise suitable logic, circuitry, and/or code that may be operable to transmit and/or receive audio information and present audio information to a user. In this regard, the far-end wireless device 360 may output audio 362 to a user and may communicate audio 357 over the wireless channel 355.

The wireless channel 355 may, for example, comprise a channel of a wireless telecommunications network. Exemplary standards utilized for communicating over the channel 355 may comprise global system for mobile communications (GSM), universal mobile telecommunications system (UMTS), and CDMA and any variants thereof such as CDMA2000.

In an exemplary embodiment of the invention, the wireless devices 350 and 360 may be smart phones and a call may be in progress between the two phones. Audio content at the near-end wireless device 350 may comprise voice data 351 from a near-end user (e.g., sidetone); audio data 352 which may comprise, for example, received radio data, audio played back from a storage device, and/or audio from an input device; and audio 357 received the via the channel 355. The near-end wireless device 350 may mix content from the various audio sources to generate audio 354 for output to a near-end user. In this manner, a near-end user may be presented with a composite audio signal comprising the voice data 351, the audio 357 received via the channel 355, and the audio 352 being received and/or generated locally. Additionally, the near-end wireless device 350 may mix content from the various audio sources for transmission over the channel 355. In this regard, the audio feedback path 353 may, for example, comprise one or more switching elements configurable to couple or decouple a source of the audio content 352 from an uplink signal path. Depending on the configuration of the feedback path 353, audio 356 transmitted over the channel 355 may comprise just the voice data 351 or may comprise the voice data 351 and the audio content 352. Accordingly, depending on the configuration of the feedback path 353, the audio 362 output by the far-end device 360 may comprise just voice data 351 and voice data 361 or may comprise voice 351, voice data 361, and the audio content 352. In this manner, audio generated and/or received locally by the near-end wireless device 350 may be shared with the far-end device.

In other embodiments of the invention, just the audio content 352 may be communicated to the far-end wireless device 360 via the channel 355. In this regard, in addition to enabling the feedback path 353, a dedicated music and/or audio sharing mode may be enabled.

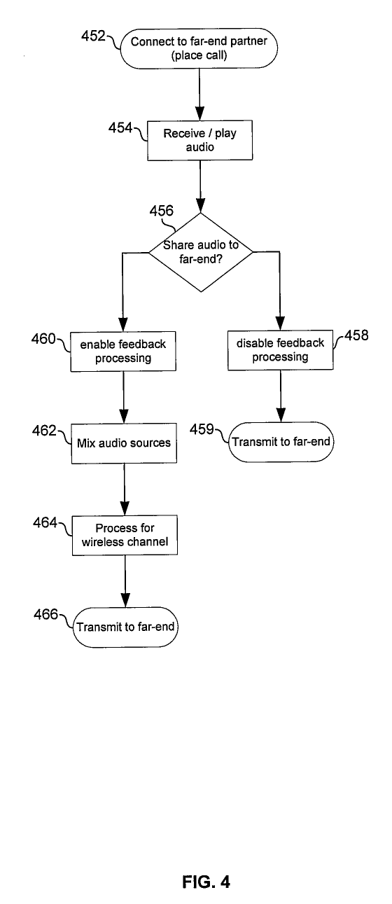

FIG. 4 is a flow chart illustrating exemplary steps for sharing audio with a far-end communication partner via a feedback processing path, in accordance with an embodiment of the invention. Referring to FIG. 4, the exemplary steps may begin with step 452 when a communication session may be established between a near-end communication partner and a far-end communication partner. For example, a phone call may be placed between the communication partners. Subsequent to step 452, the exemplary steps may advance to step 454. In step 454, audio content, other than the voice content exchanged for the phone call, may be received and/or played back by the near-end communication partner. For example, the near-end partner may playback locally stored audio content from the memory 158 or tune in an audio broadcast and the audio may be output via a speaker, headset, or other near-end output device. Subsequent to step 454, the exemplary steps may advance to step 456.

In step 456, it may be determined whether the audio content is to be fed-back to an uplink path for transmission to the far-end communication partner. In instances that the audio is to be communicated to the far-end partner, the exemplary may advance to step 460.

In step 460, a feedback processing path may be enabled. For example, the routing matrix 504 described with respect to FIG. 2B may be configured to convey one or more audio signals to the mixers 506_{θ+2} and 510_{θ+2}. Subsequent to step 460, the exemplary steps may advance to step 462.

In step 462, the audio content may be mixed with the voice content to generate a composite audio signal to be conveyed to the far-end communication partner. Subsequent to step 462, the exemplary steps may advance to step 464.

In step 464, the composite audio signal may be processed to make it suitable for transmission over the wireless connection between the communication partners. For example, the composite audio signal may be down-sampled so that it meets bandwidth limitations of the wireless channel. Subsequent to step 464, the exemplary steps may advance to step 466.

In step 466, the composite audio signal may be transmitted to the far-end communication partner.

Returning to step 456, in instances that the audio is not to be communicated to the far-end partner, the exemplary steps may advance to step 458. In step 458, a feedback processing path in the audio CODEC 464 may be disabled. For example, the routing matrix 504 described with respect to FIG. 2B may be configured so as not to convey audio to the mixers 506_{θ+1} and 510_{θ+1}. Subsequent to step 458, the exemplary steps may advance to the step 459, wherein the voice may be transmitted to the far-end communication partner.

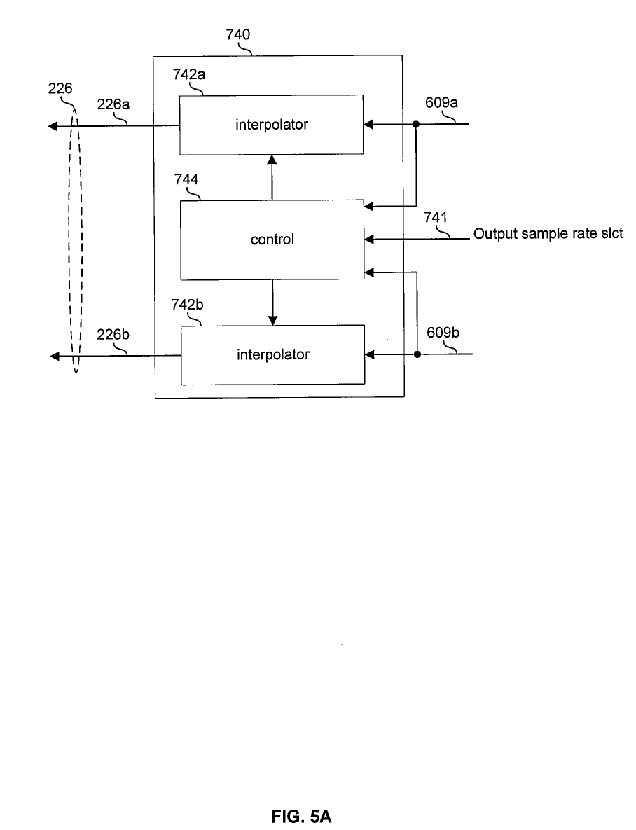

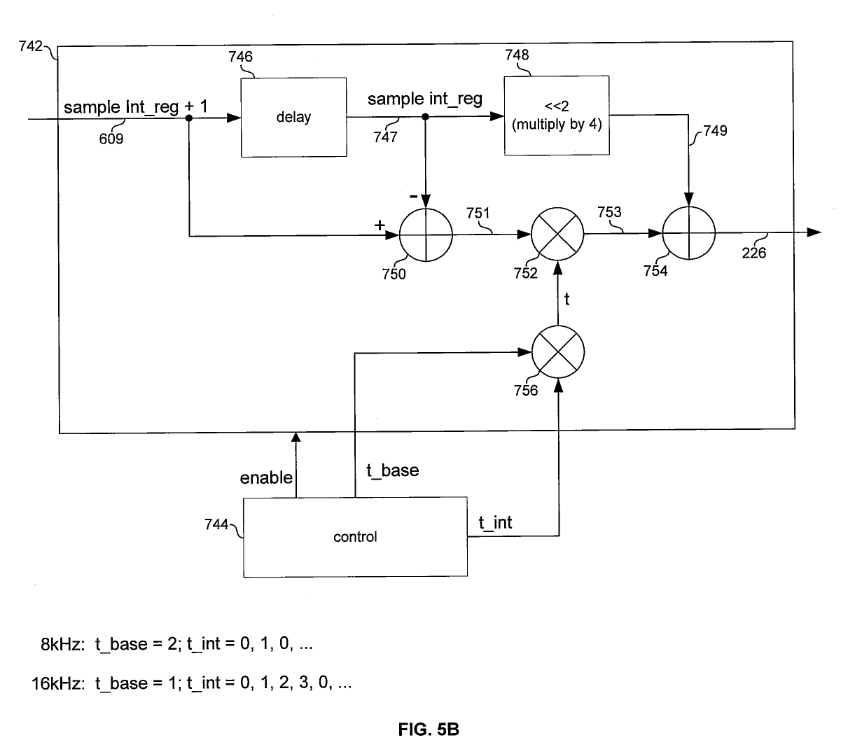

FIG. 5A is a block diagram illustrating an exemplary audio feedback audio processing block, in accordance with an embodiment of the invention. Referring to FIG. 5A the feedback audio processing block 740 may comprise interpolators 742a and 742b and control block 744. Although portions of the feedback audio processing block 740 are described with respect to an ‘A’ signal path, operation of a ‘B’ signal path may be substantially the same as the ‘A’ signal path, as indicated by the reference designators in brackets.

The interpolator 742a {742b} may comprise suitable logic, circuitry, and/or code that may be operable to generate a sample of the feedback signal 226a {226b} based on one or more samples of the signal 609a {609b}. An exemplary embodiment of the interpolator 742a {742b} is described below with respect to FIG. 5B.

The control block 744 may comprise suitable logic, circuitry, and/or code that may be operable to control and/or manipulate operation of the interpolators 742a and 742b. In this regard, the control block 744 may provide one or more enable signals to the interpolators 742a and 742b to determine when a sample of the output signals 226 may be generated. Additionally, the control block 744 may provide one or more coefficients to the interpolators 742a and 742b to determine, in part, sample values for the signals 226. To determine output and input sampling rates, the control block 744 may receive one or more control signals from, for example, the DSP 154 and/or the processor 156. In an exemplary embodiment of the invention, the signal 741 may select one of a plurality of possible input sampling rates corresponding to the signals 609 and may select one of a plurality of possible output sampling rates corresponding to the signals 226.

In operation, input signal 609a {609b} may be input to the feedback audio processing block 740. The control block 744 may be clocked by the input signals 609a {609b} and/or a corresponding clock signal and may output an enable signal to the interpolators 742 at time instants that the interpolator 742a {742b} may generate a sample of the output signal 226a {226b}. Additionally, for each sample of the output signal 226a {226b}, the control block 744 may provide coefficients for calculating the value of the sample. For example, a sample value of the signal 226a {226b} may be a weighted average of two adjacent samples of the input signal 609a {609b}. In this regard, the interpolator may be a linear interpolator and may be as described below with respect to FIG. 5B. In various exemplary embodiments of the invention, higher order polynomial interpolators or FIR interpolators may be utilized to achieve greater signal quality but at the expense of greater cost and/or complexity.

FIG. 5B is a block diagram illustrating an exemplary linear interpolator, in accordance with an embodiment of the invention. Referring to FIG. 5B, the interpolator may comprise a delay block 746, a bit shift operation 748, adders 750 and 754, and multipliers 752 and 756.

The delay block 746 may comprise suitable logic, circuitry, and/or code that may be operable to delay the input signal by one input sample. In an exemplary embodiment of the invention, the delay block 746 may comprise a flip-flop clocked by a clock signal recovered from, or synchronous with, the audio signal 609.

The bit shift operation 748 may comprise suitable logic, circuitry, and/or code that may be operable to multiply the value of the input signal 609 by four. In this regard, the signal 747 may be left shifted by two bits with the two LSB's replaced by zeros to generate sample of the signal 749.

The adders 750 may each comprise suitable logic, circuitry, and/or code that may be operable to add and/or subtract audio sample values. The adder 750 may subtract the a sample of the output signal 747 from a sample of the input signal 609 to generate a sample of the signal 751. The adder 754 may add a sample of the signal 753 to a sample of the signal 749 to generate a sample of the signal 226.

The multipliers 752 and 756 may each comprise suitable logic, circuitry, and/or code that may be operable to multiply digital values. The multiplier 756 may multiply the values of t_base and t_int from the control block 744 to generate the coefficient ‘t’ which may be utilized to calculate a sample value of the output signal 226. In this regard, a sample value of the output signal 226 may be determined by the following relation:

S₂₂₆=(1−t)·S₆₁₁+t·S₇₄₇ EQ. 1

where S₂₂₆ is the sample value output to the DSP 154, and S₇₄₇ and S₆₀₉ are values of a pair of adjacent samples of the input signal 609 utilized for calculating the output sample value. In this manner, a linear interpolation between S₆₀₉ and S₇₄₇ may be utilized to generate a sample of the output signal 226.

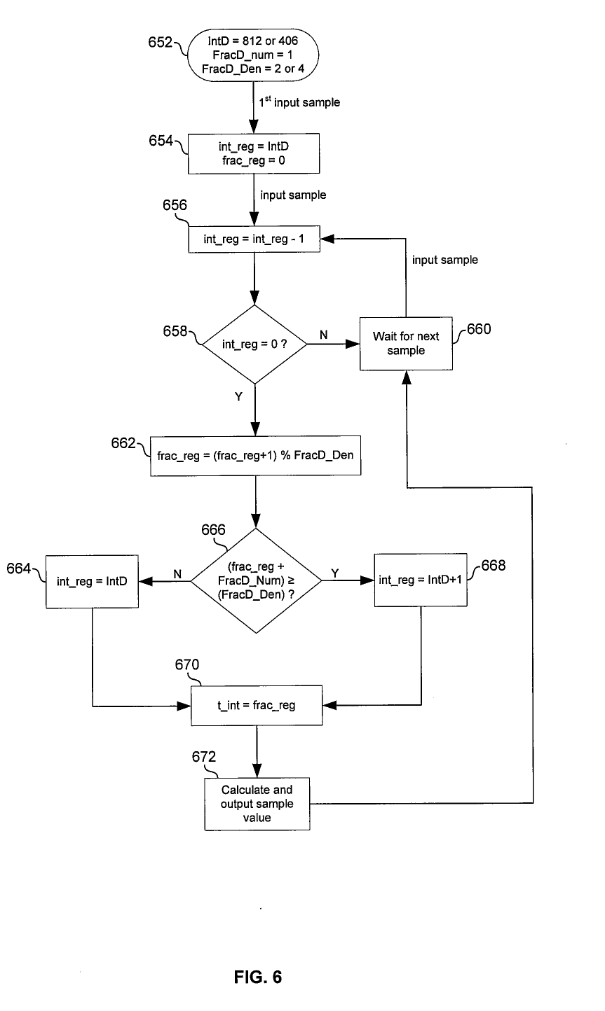

FIG. 6 is a flow chart illustrating exemplary steps for down-sampling audio signals to generate a feedback signal for transmission to a far-end communication partner, in accordance with an embodiment of the invention. Referring to FIG. 6, the exemplary steps may begin with step 652 where variables ‘IntD’, ‘FracD_Num’, and ‘FracD_Den’ may be initialized. In this regard, ‘IntD’ may be a constant corresponding to the integer part of the decimation ratio and ‘FracD_Num’/‘FracD_Den’ may be a constant corresponding to the fractional part of the decimation ration, where the decimation ratio may be the input sample rate divided by the output sample rate. In this regard, an output sample may be generated every (IntD+‘FracD_Num’/‘FracD_Den’) input samples. In an exemplary embodiment of the invention, 6.5 MHz may be down-sampled to 16 kHz and the decimation ratio may be 6.5 MHz/16 kHz=406.25. Accordingly, ‘IntD’ may be set so that it may be equal to 406, ‘FracD_Num’ may be set so that it may be equal to 1, and ‘FracD_Den’ may be set so that it may be equal to 4. Accordingly, the sampling instant of the first sample may be sample number 406.25 of the input signal. However, the input signal may be a digital signal and a sample 406.25 may not exist. The value of the output signal at sampling instant 406.25 may be determined via a weighted average of input samples 406 and 407. Subsequent to step 652, the exemplary steps may advance to step 654.

In step 654, a variable ‘int_reg’ may be set equal to ‘IntD’ and a variable ‘frac_reg’ may be set equal to 0. In this regard, ‘int_reg’ may be utilized to track an integer number of input samples and determine which samples of the input signal are a pair of adjacent input samples to be utilized for calculating an output sample. Similarly, ‘frac_reg’ may be utilized to track the fractional portion of the decimation ratio. Subsequent to step 654, and coincident with an arrival of an input sample, the exemplary steps may advance to step 656.

In step 656, ‘int_reg’ may be decremented by one. In this manner, ‘int_reg’ may be decremented with the arrival of each input sample. Subsequent to step 656, the exemplary steps may advance to step 658.

In step 658, it may be determined whether ‘int_reg’ is equal to 0. In this regard, step 658 may determine whether it may be time to trigger the calculation of an output sample. In instances that ‘int_reg’ is not equal to 0, the exemplary steps may advance to step 660. In step 660, the exemplary steps may await the next input sample. Upon arrival of the next input sample, the exemplary steps may return to step 656.

Returning to step 658, in instances that ‘int_reg’ is equal to 0, the exemplary steps may advance to step 662. In step 662, ‘frac_reg’ may be set equal to the remainder of (‘frac_reg’+‘FracD_num’)/‘FracD_Den’. In this regard, ‘int_reg’ may be incremented by ‘FracD_Num’ on each output sample and may wrap to 0 every ‘FracD_Den’ output samples. In an exemplary embodiment of the invention, for ‘FracD_Num’=1 and ‘FracD_Den’=4, ‘frac_reg’ may repeatedly cycle through the sequence of values 0, 1, 2, 3. Subsequent to step 662, the exemplary steps may advance to step 666. In step 666 the relation (‘frac_reg’+FracD_Num)≧(‘FracD_Den’) may be evaluated. In instances that the relation evaluates false, the exemplary steps may advance to step 664.

In step 664, ‘int_reg’ may be set equal to ‘IntD’. In this regard, step 664 may correspond to output samples for which the sampling instant of the next output signal may not correspond to an integer. For example, for a decimation ratio of 406.25, the first sampling instant may be 406.25 and the next sampling instant may be 812.5 which is not an integer. Subsequent to step 664, the exemplary steps may advance to step 670.

Returning to step 666, in instances that the relation (‘frac_reg’+FracD_Num)≧(‘FracD_Den’) evaluates true, the exemplary steps may advance to step 668. In step 668, ‘int_reg’ may be set equal to ‘IntD’+1. In this regard, step 668 may correspond to output samples for which the sampling instant of the next output signal may correspond to an integer. For example, for a decimation ratio of 406.25, the third sampling instant may be 1218.75 and the next sampling instant may be 1635 which corresponds to an integer. In other words, for every fourth output sample the fractional portion of the decimation ratio has accumulated to one input sample. Subsequent to step 668, the exemplary steps may advance to step 670.

In step 670. ‘t_int’ may be set equal to ‘frac_reg’. In this regard, ‘t_int’ may determine the coefficient ‘t’ utilized to calculate the output sample value, as described above in FIG. 5B. Subsequent to step 670, the exemplary steps may advance to step 672.

In step 672, the value of the output sample may be calculated utilizing EQ. 1 above. Subsequent to step 672, the exemplary steps may advance to the previously described step 660.

Exemplary aspects of a method and system for audio feedback processing in an audio CODEC are provided. In an exemplary embodiment of the invention, in a hardware audio CODEC 164 of a wireless device 150, voice content 351 from a first audio source may be mixed with audio content 352 from one or more second audio sources to generate a composite audio signal 356. The generated composite audio signal 356 may be transmitted to one or more far-end communication partners 360 via a wireless communication channel 355. The wireless communication channel 355 may be a channel of a cellular network. Exemplary audio sources may comprise a digital microphone 176, an analog microphone 168, a digital storage medium 158, a BT/USB subsystem 162, and a receiver 153.

The composite audio signal 354 may also be mixed with audio content 357 from a far-end communication partner 360 to generate a composite audio signal 354, which may be output to a local user via one or more audio output devices 209. The audio content may comprise voice, music, and/or ringtone. The content from the one or more second audio sources may comprise music played from the digital storage medium 158 within the wireless device 150 and/or music extracted from a signal received by the BT and/or USB subsystem 162 and/or the receiver 153. The composite audio signal 356 may be down-sampled to meet bandwidth limitations of the wireless communications channel 355. Mixing, down-sampling, and/or transmitting performed by the wireless device 150 may be enabled and disabled via one or more control signals. Prior to or during said mixing, audio signal levels from each of the audio sources 209 may be controlled independently.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for audio feedback processing in an audio CODEC.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. One embodiment may utilize a commercially available processor, which may be implemented external to an ASIC implementation of the present system. Alternatively, in an embodiment where the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for signal processing the method comprising:
in a wireless device operating as a near-end communication partner:
mixing, via a hardware audio CODEC, voice content from a first audio source with audio content from one or more second audio sources to generate a composite audio signal; and
transmitting said generated composite audio signal via a wireless communication channel to one or more far-end communication partners.

2. The method according to claim 1, wherein said wireless communication channel is a channel of a cellular network.

3. The method according to claim 1, comprising mixing said composite audio signal with audio received from said one or more far-end communication partners and outputting a resulting audio signal to a local user via one or more audio output devices.

4. The method according to claim 1, wherein said first audio source and said one or more second audio sources comprise one or more of a digital microphone, an analog microphone, a broadcast radio receiver, a Bluetooth receiver, a USB receiver, and a digital storage medium.

5. The method according to claim 1, wherein said audio content comprises voice, music, and/or ringtone.

6. The method according to claim 1, wherein said audio content from said one or more second audio sources comprises music played from a digital storage medium within said wireless device.

7. The method according to claim 1, wherein said audio content from said one or more second audio sources comprises music extracted from a signal received by a broadcast radio receiver, a Bluetooth receiver, or a USB receiver within said wireless device.

8. The method according to claim 1, comprising down-sampling said composite audio signal to meet bandwidth limitations of said wireless communication channel.

9. The method according to claim 8, wherein said mixing, said down-sampling, and/or said transmitting in said wireless device is enabled and disabled via one or more control signals.

10. The method according to claim 1, comprising independently controlling audio signal levels from each of said audio sources prior to or during said mixing.

11. A system for signal processing the method comprising:
one or more circuits for use in a hardware audio CODEC within a wireless device operating as a near-end communication partner, wherein said one or more circuits are operable to:
mix voice content from a first audio input with audio content from one or more second audio inputs to generate a composite audio signal; and
transmit said generated composite audio signal via a wireless communication channel to one or more far-end communication partners.

12. The system according to claim 11, wherein said wireless communication channel is a channel of a cellular network.

13. The system according to claim 11, wherein said one or more circuits are operable to mix said composite audio signal with audio received from said one or more far-end communication partners and output a resulting audio signal to a local user via one or more audio output devices.

14. The system according to claim 11, wherein said first audio source and said one or more second audio sources comprise one or more of a digital microphone, an analog microphone, broadcast radio receiver, a Bluetooth receiver, a USB receiver, and a digital storage medium.

15. The system according to claim 11, wherein said audio content comprises voice, music, and/or ringtone.

16. The system according to claim 11, wherein said audio from said one or more second audio sources comprises music played from a digital storage medium within said wireless device.

17. The system according to claim 11, wherein said audio from said one or more second audio sources comprises music extracted from a signal received by a broadcast radio receiver, a Bluetooth receiver, or a USB receiver within said wireless device.

18. The system according to claim 11, wherein said one or more circuits are operable to down-sample said composite audio signal to meet bandwidth limitations of said wireless communication channel.

19. The system according to claim 18, wherein said mixing, said down-sampling, and/or said transmitting in said wireless device is enabled and disabled via one or more control signals.

20. The system according to claim 11, wherein said one or more circuits are operable to independently control audio signal levels from each of said audio sources prior to or during said mixing.
